(19) United States
(12) Patent Application Publication
(10) Pub. No.: US 2024/0218138 A1
(43) Pub. Date: Jul. 4, 2024

(54) NOVEL PHOSPHONATED FLUOROELASTOMERS (PFKMS), PHOSPHONATED PERFLUOROELASTOMERS (PFFKMS), THEIR PROCESS OF PREPARATION AND USE IN ELECTROMEMBRANE APPLICATIONS

(71) Applicant: Riva Power Systems GmbH & Co. KG, Backnang (DE)

(72) Inventor: Andreas CHROMIK, Rudersberg (DE)

(73) Assignee: Riva Power Systems GmbH & Co. KG, Backnang (DE)

(21) Appl. No.: 18/570,118

(22) PCT Filed: Jun. 23, 2022
(86) PCT No.: PCT/DE2022/100467

§ 371 Date: Dec. 14, 2023

(30) Foreign Application Priority Data
Jun. 23, 2021 (DE) 10 2021 003 229.2

(51) Int. Cl. C08J 5/22; B01J 39/05; B01J 39/20; B01J 47/12; C08F 214/18; H01M 4/62; H01M 8/10; H01M 8/1034; H01M 8/1039; H01M 50/426

(52) U.S. Cl. CPC C08J 5/225; B01J 39/05; B01J 39/20; B01J 47/12; C08F 214/18; H01M 4/623; H01M 8/1034; H01M 8/1039; H01M 50/426; C08F 2810/00; C08J 2327/22; H01M 2008/1095

(57) ABSTRACT

The disclosure relates to a class of high and low phosphonated aliphatic fluoropolymer rubbers (pFKM) and perfluoropolymer rubbers (pFFKM) based on FKM and FFKM as well as the process for their preparation and their applications.

### CROSS-REFERENCE TO RELATED APPLICATION

This application is a national stage application, filed under 35 U.S.C. § 371, of International Patent Application PCT/DE2022/100467, filed on Jun. 23, 2022, which claims the benefit of German Patent Application DE 10 2021 003 229.2, filed on Jun. 23, 2021.

### TECHNICAL FIELD

Novel phosphonated fluoroelastomers (pFKMs), phosphonated perfluoroelastomers (pFFKMs), their preparation process and their use in electro membrane applications.

### BACKGROUND

The most commonly described phosphonated systems are based on aryl polymers synthesized by nucleophilic substitution (via Michaelis-Arbusow and Michaelis-Becker rearrangements) of aryl halides and di- or trialkyl phosphite, as described for example in DE 10 2011 015 212 A1.

These phosphonated aryl polymers are characterized by their high thermal and chemical stability. In addition, they show good proton conductivity, even in the non-humidified state, at temperatures above 100° C.

Disadvantages of phosphonated aryl polymers, e.g. from DE 10 2011 015 212 A1, is that they are mechanically unstable and brittle in the dry or non-humidified state.

### SUMMARY

The inventive step is based on finding new phosphonated compounds which are proton conducting, chemically and mechanically stable, even in the dry state and at high temperatures. These compounds should furthermore be easy to synthesize. This is achieved by phosphonating non-conductive polymers such as FKM (Fluoro rubber) or FFKM (Perfluoro rubber) with trialkyl phosphites such as Tris(trimethylsilyl)phosphite (TTMSP). The basic rubbers FKM and FFKM already have a high mechanical flexibility, both at very low and very high temperatures, and are chemically stable.

Unexpectedly they retain these good mechanical and chemical properties after phosphonation, are good proton conductors, even at temperatures above 100° C. and are soluble in organic solvents.

So far, no compounds are synthesized that have these positive properties or are synthesized via this production method. Thus, the polymers synthesized here represent a new class of materials and the associated production process.

The reaction should be as efficient and simple as possible, which is the case described here, since the unused phosphonating agent can be recovered.

The phosphonated polymers should be soluble in common solvents in order to be able to produce membranes from them.

The phosphonation reaction can be carried out with all FKM, FFKM derivatives in the listed classification Type 1 to Type 5 below. It is irrelevant which monomer ratios the FKM or FFKM is composed of, the sole relevant condition is that monomer components with a reactive group —X are present in the FKM or FFKM, see exemplary FIG. 1.
Type 1 copolymers consisting of vinylidene fluoride (VDF) and hexafluoropropylene (HFP)
Type 2 terpolymers consisting of VDF, HFP and Tetrafluoroethylene (TFE)
Type 3 consisting of VDF, TFE and perfluoroalkylvinylether (PAVE)
Type 4 consisting of TFE, VDF and propylene
Type 5 consisting of VDF, HFP, TFE, PAVE, ethylene and perfluoroelastomers mainly consisting of TFE and PAVE

The invention is based on the reaction of a reactive group —X of the fluoro rubbers and perfluoro rubbers with TTMSP or a side chain consisting of a bisphenol AF which is already linked to the aliphatic polymer backbone. The reactive group —X (FIG. 1), depending on the base material, can be —I, —Br, —Cl, —H or the free —OH of the bisphenol AF side chain, or a pseudo halogen (—CN, —N3, —OCN, —NCO, —CNO, —SCN, —NCS, —SeCN).

As a non-restrictive example, the basic structure of a perfluoro elastomer (FFKM) is shown in FIG. 1, where n, m and z can be mixed in any ratio, with the building block z, determining the number of phosphonatable sites.

The only important factor for the phosphonation reaction is that there is a reactive group —X in the FKM/FFKM that can react with TTMSP.

The phosphonated polymers may still contain free reactive groups —X depending on the degree of phosphonation. Subsequently these free groups can be used to covalently crosslink the phosphonated polymers. The phosphonation to pFKM and pFFKM takes place in solution. For this purpose, the base polymers can be dissolved in ethyl acetate, butanone, N-methylpyrolidone (NMP), dimethylacetamide (DMAc), dimethylsulphoxide (DMSO), etc. TTMSP can optionally be added before, directly during the dissolving process or after the polymers are dissolved. Depending on the desired degree of phosphonation, 0.1 wt. % (weight percent), low degree of phosphonation, to 5000 wt. %, high degree of phosphonation, based on the polymer weight TTMSP is added.

Depending on the FKM/FFKM used, the base material dissolves in the solvent before phosphonation or after phosphonation takes place.

The reaction works best and fastest in aprotic solvents with high-boiling points such as NMP, DMAc and DMSO. During the reaction, gas evolution can be observed, which indicates the start of the reaction. Trimethylsilyl-X (TMS-X) is formed as a by-product.

The reaction is kept at reaction temperature (60° C. to 200° C.), depending on the FKM/FFKM and solvent used, until the gas evolution stops. The reaction is then kept at the reaction temperature for further 2 to 8 hours to be sure that the reaction is complete.

The TMS-X and excess TTMSP are removed by distillation. The phosphonated polymer, in the form of trimethylsilyl ester of pFKM or pFFKM, remain in the solvent.

The polymer solution is now added into water and, depending on the degree of phosphonation, precipitates as a solid (low degree of phosphonation) or goes into solution (high degree of phosphonation). By boiling the water/polymer mixture, the phosphonated polymer is hydrolyzed from its trimethylsilyl ester form to the polymeric phosphonic acid.

To completely separate hydrolysis byproducts, the polymer can be washed in water depending on the degree of phosphonation. Non-water-soluble pFKM/pFFKM or fractions can be washed and separated by filtration, water-soluble ones can be purified by dialysis.

Another method is not to precipitate the polymer solution in water, but to directly process the polymer solution into a membrane and then hydrolyze the polymer membrane in hot water. The resulting polymers and membranes can be used in electrochemical cells. Preferably, the polymers or blended membranes can be used in low or medium temperature fuel cells in the temperature ranges of −30° C. to 250° C. or in low or medium temperature electrolysers in the temperature ranges from 0° C. to 250° C. In addition, the membranes can be used in chemical synthesis reactors from −70° C. to 250° C. The membranes can also be used as separators in primary and secondary batteries or as binders in electrodes of primary and secondary batteries.

### BRIEF DESCRIPTION OF THE DRAWINGS

FIG. 1: Example of the basic structure for an FFKM with reactive group —X

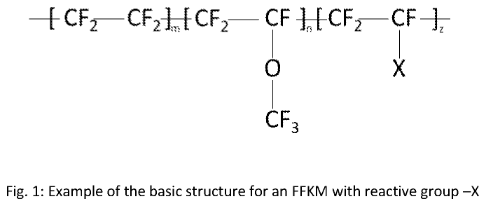

FIG. 2: Conductivities of the phosphonated polymers (top) and for comparison (bottom) of a Nafion 212 measured at 50% RH at 30° C. decreasing to 0.2% RH at 180° C.

FIG. 3: Polarization curve of a membrane made of the phosphonated polymer with IECₜₒₜₐₗ=2.62 mmol/g, showing that phosphonation has taken place and that the application in electrochemical cells works.

FIG. 4: Exemplary reaction scheme of the phosphonation reaction.

### DETAILED DESCRIPTION

### Non-Limiting Embodiment Example

10 g of an FKM is mixed with 90 g of N-methylpyrolidone (NMP), stirred, heated and dissolved. 50 g of TTMSP is added to the solution and heated to 160° C. After a few minutes, gas starts to evolve, which first accelerates and then slowly comes to a standstill, indicating the end of the reaction. The solution is kept at reaction temperature for another 2 to 12 hours to make sure that the reaction is complete.

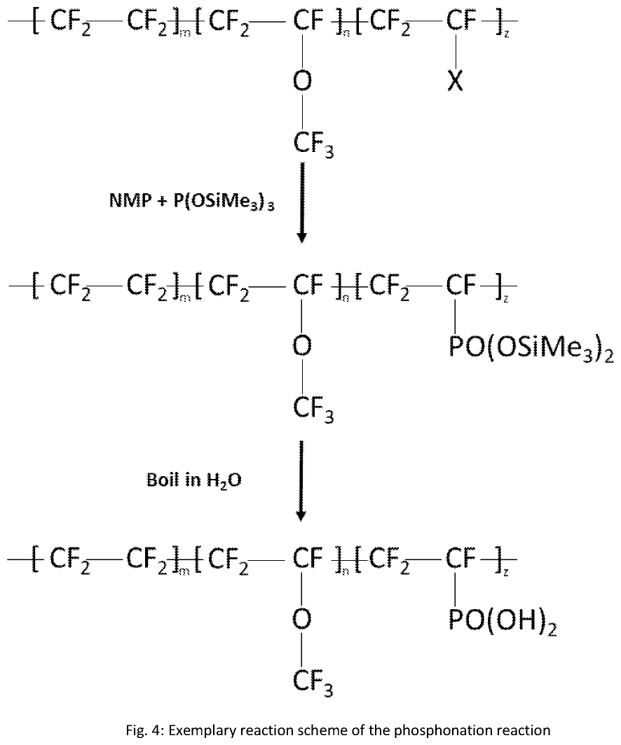

Now the byproducts and excess TTMSP can be removed by distillation. The pFKM dissolved in the NMP can now either be precipitated in water or a membrane can be prepared directly from the reaction solution. Both the precipitated and the direct casting variant still needs to be post treated in hot to boiling water or post treated with hot steam to obtain the—phosphonic acid form (FIG. 4).

### Analysis of the Experiment

Here, one of the phosphonated polymers with different degrees of phosphonation is described as an example including, its ion exchange capacity, conductivity up to 180° C. and an electrolysis test as proof of concept.

### Determination of the Ion Exchange Capacity

100 mg of the prepared polymer are covered with a saturated NaCl solution and stirred for approximately 2 h, 2 drops of bromothymol blue are added as indicator. The protons of the phosphonated pFKM exchange with the Na ions and HCl is formed. The HCl formed is detected by titration with 0.1 mol NaOH. From this, the IEC_{direct} can be determined. To determine the total IEC, 3 ml NaOH 0.1 M is added in excess to the same solution, stirred again for another 2 h and then titrated back with HCl.

For the above described experiment an IEC_{direct}=0.99 mmol/g and IECₜₒₜₐₗ=2.62 mmol/g is obtained.

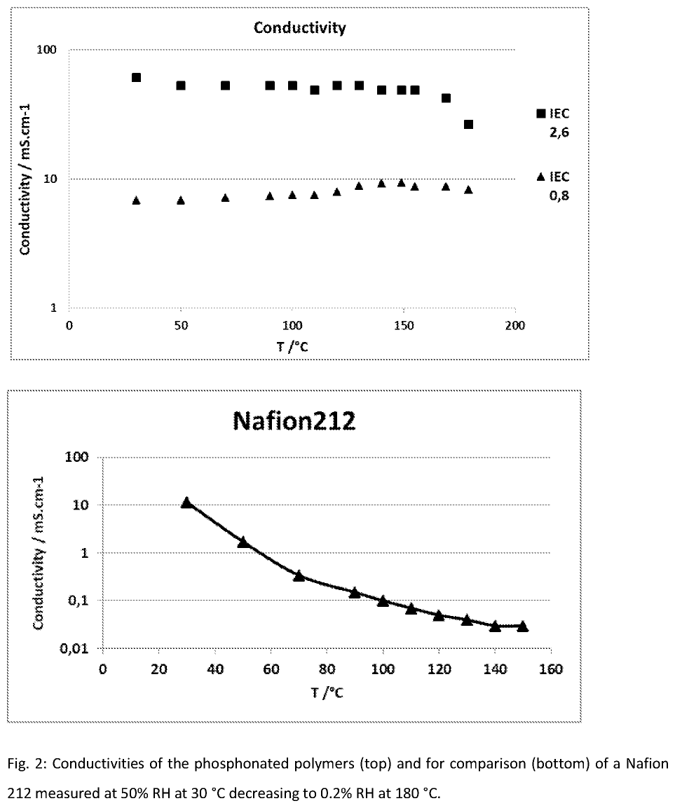

If the same experiment is carried out with 10 g FKM and 10 g TTMSP, an IEC_{direct}=0.56 mmol/g and IECₜₒₜₐₗ=0.8 mmol/g is obtained. This clearly shows the relationship between the reactant ratios, the degree of phosphonation and the conductivity (FIG. 2).

### Conductivity

In FIG. 2, the influence of the degree of phosphonation on the conductivity can be seen well and also that the conductivity does not decrease above 100° C. and thus new types of electrochemical cells, above 150° C., are possible. For comparison to the state of the art, a Nafion 212 with the same measurement conditions is also displayed.

Proof of concept electrolysis test with IECₜₒₜₐₗ=2.6 mmol/g membrane

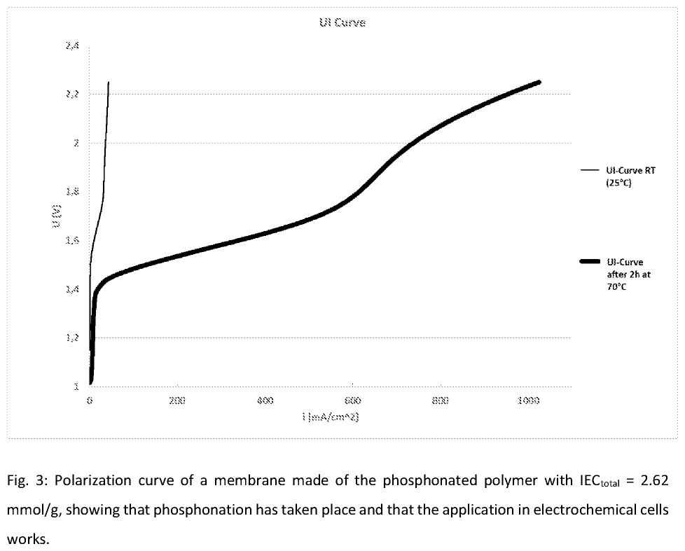

A membrane was made from the phosphonated polymer with the IECₜₒₜₐₗ=2.6 mmol/g and this membrane was measured in an electrolysis cell, demonstrating that the application in electro membrane processes is possible (FIG. 3).

1.-18. (canceled)

19. A phosphonated polymer, comprising:
an aliphatic polymer backbone; and
a phosphonic acid group,
wherein the phosphonated polymer is selected from the group consisting of phosphonated aliphatic fluoropolymer rubbers (pFKM) synthesized from fluoropolymer rubber (FKM) and phosphonated aliphatic perfluoropolymer rubbers (pFFKM) synthesized from perfluoropolymer rubber (FFKM),
wherein the phosphonic acid group is present directly on the backbone or on a side chain of the phosphonated polymer.

20. The phosphonated polymer according to claim 19,
wherein the backbone of the phosphonated polymer comprises two or more monomers selected from the group consisting of vinylidene fluoride (VDF), hexafluoropropylene (HFP), tetrafluoroethylene (TFE), perfluoroalkylvinylether (PAVE), propylene, and ethylene, and
wherein the phosphonated polymer can be shaped into a membrane.

21. The phosphonated polymer according to claim 19,
wherein unreacted reactive groups (—X) without phosphonic acid group are present,
wherein the unreacted reactive groups (—X) can be covalently crosslinked to produce covalently crosslinked membranes, and
wherein the unreacted reactive groups (—X) are selected from the group consisting of —I, —Br, —Cl, —HCN, —N3, —OCN, —NCO, —CNO, —SCN, —NCS, —SeCN, and free —OH of a bisphenol AF side chain.

22. A membrane, comprising:
the phosphonated polymer according to claim 19, blended with
a basic polymer selected from the group consisting of polybenzimidazole and anion exchange polymers,
the membrane being an acid-base blend membrane, a covalently crosslinked membrane, or a covalently crosslinked acid-base blend membrane.

23. The membrane according to claim 22,
wherein a mixing ratio between the phosphonated polymer and the basic polymer is between 99 mol % phosphonated polymer and 1 mol % basic polymer to 1 mol % phosphonated polymer and 99 mol % basic polymer.

24. The membrane according to claim 22, further comprising a sulfonated polymer.

25. A method, comprising:
doping the membrane as in claim 22 with phosphoric acid.

26. A method, comprising: doping the membrane as in claim 22 with phosphoric acid, a doping level of the phosphoric acid being between 40 wt. % and 500 wt. %.

27. A method for preparing a phosphonated polymer, comprising:
dissolving or suspending FKM or FFKM in a phosphonating agent;
heating the dissolved or suspended FKM or FFKM to temperatures between 40° C. to 200° C. for 30 minutes to 12 hours; thereafter
distilling off or otherwise removing excess phosphonating agent; and
isolating the phosphonated polymer by dialysis or precipitation,
wherein the FKM or FFKM has at least one reactive group (—X),
wherein the least one reactive group (—X) is at least one member selected from the group consisting of —I, —Br, —Cl, —H, —CN, —N3, —OCN, —NCO, —CNO, —SCN, —NCS, —SeCN, and free —OH of a bisphenol AF side chain.

28. The method according to claim 27, wherein dissolving or suspending FKM or FFKM in a phosphonating agent comprises adding at least one further solvent.

29. The method according to claim 28, wherein the further solvent is at least one member selected from the group consisting of N-methylpyrolidone (NMP), Dimethylecetamide (DMAc), and Dimethylsulfoxide (DMSO).

30. The method according to claim 27, wherein the phosphonating agent is tris(trimethylsilyl)phosphite.

31. An electrochemical cell comprising the phosphonated polymer according to claim 19.

32. A low or medium temperature polymer electrolyte fuel cells PEM fuel cells in a temperature range from −30° C. to 250° C. comprising the phosphonated polymer according to claim 19.

33. A low- or medium temperature PEM electrolysers in a temperature range from 0° C. to 250° C. comprising the phosphonated polymer according to claim 19.

34. A chemical synthesis reactor from −70° C. to 250° C. comprising the phosphonated polymer according to claim 19.

35. A separator in a primary battery or a secondary battery comprising the phosphonated polymer according to claim 19.

36. A binder in an electrodes of a primary battery or a secondary battery comprising the phosphonated polymer according to claim 19.
